(19) United States
(12) Patent Application Publication
(10) Pub. No.: US 2008/0158364 A1
(43) Pub. Date: Jul. 3, 2008

(54) Image Processing Device and Data Processing Method

(76) Inventors: Hiroshi Miyajima, Fukuoka (JP); Masayoshi Toujima, Fukuoka (JP)

Correspondence Address: WENDEROTH, LIND & PONACK L.L.P., 2033 K. STREET, NW, SUITE 800, WASHINGTON, DC, 20006, US

(21) Appl. No.: 10/592,826

(22) PCT Filed: May 11, 2005
(86) PCT No.: PCT/JP2005/009023

§ 371 Date: Sep. 14, 2006

(30) Foreign Application Priority Data
May 20, 2004 (JP) 2004-150506

(51) Int. Cl. H04N 5/225

(52) U.S. Cl. 348/207.1; 348/E05.001

(57) ABSTRACT

An image processing device (100) of the present invention comprises a bus (10), an image processing module group (20), a controller (30), a memory (40), and a format converting module (50). The format converting module (50) is installed between the memory (40) and the bus (10). When data formats of image data, which the image processing module group (20) and the memory (40) treat, are different, the format converting module (50) converts the data formats of the image data, and stores the converted data in the memory (40). According to the structure, since each image processing module does not need to individually possess a function of converting data formats, it is possible to reduce circuit scale of the image processing device, and efficiently perform the image processing.

### TECHNICAL FIELD

The present invention relates to an image processing device, a data processing method and their related art operable to transfer data between an image processing module and a memory, when a data format and a data allocation method are different between the image processing module and the memory.

### BACKGROUND ART

Information-and-communications terminal devices which can process pictures, as typified by a camera-equipped mobile phone in recent years, are advancing at a rapid rate. Keeping pace with it, diversification of functional blocks mounted in the information-and-communications terminal devices has also increased.

Such functional blocks are modularized for every function. There are various kinds of image processing modules in the functional blocks. For example, they include an MPEG4 codec module which performs encoding/decoding of image data based on the MPEG4 system, a motion-image compression/expansion module which performs compression/expansion of motion image data based on the MPEG2 or MPEG4 systems, a still-image compression/expansion module which performs compression/expansion of still-image data based on the JPEG system, a graphics module treating graphics, a video input module treating video inputted from a CCD camera, a video output module outputting video to an LCD display device, and others.

Each of the image processing modules employs its own unique data format in many cases, in order to demonstrate its function most efficiently. Therefore, to send and receive image data among the image processing modules or among the image processing modules and a frame memory, it is necessary to convert the data format of the image data. The data allocation method on a memory may also differ with each of the image processing modules.

In order that an image processing device, equipped with a plurality of image processing modules mentioned above, may perform a diversified range of image processing, it is necessary for the plurality of image processing modules to transfer data among them and to operate in a cooperative manner. Therefore, when data is transferred among the image processing modules, it is necessary to perform a data-format conversion processing and a data re-allocation processing.

For example, document 1 (Published Japanese patent application H05-64223) discloses technology in which an image data converting device performs the mutual conversion of YC data and RGB data. The image data converting device disclosed by the document 1 comprises an input/output means which handles the RGB data, and an image data memory which stores the YC data, and a data converting circuit, all connected to a system bus. The data converting circuit performs the mutual conversion of the YC data and the RGB data transferred between the input/output means and the image data memory via the system bus.

Document 2 (Published Japanese patent application 2000-305546) discloses technology on a semiconductor memory, which is provided with a format conversion unit operable to perform the format conversion of the image data which is transferred between a memory cell array storing the image data, and an interface connecting to the outside.

However, according to the conventional technology disclosed by the document 1, when image data is transferred in an image processing device composed of various image processing modules which possess individually different data formats, more specifically, when the image data is transferred among the various image processing modules or between the various image processing modules and the image data memory, execution of required conversion of a data format by the image data converting device connected to the system bus may bring about the congestion on the system bus, due to increased frequency of usage of the system bus. Therefore, it is impossible to execute efficient conversion of the data format.

In the conventional technology disclosed by the document 2, it is difficult to perform manifold data-format conversions efficiently in the image processing device provided with many image processing modules which possess individually different data formats.

Furthermore, these conventional technologies cannot respond at all to data conversion that should treat different data allocation methods.

### DISCLOSURE OF THE INVENTION

In view of the above, an object of the present invention is to provide an image processing device which can perform efficiently data-format conversion processing and data re-allocation processing at the time of performing data transfer between a plurality of image processing modules and between one of the plurality of image processing modules and a memory, in order to realize various kinds of image processing with the collaborative operation of the plurality of image processing modules.

A first aspect of the present invention provides an image processing device comprising: a bus; a plurality of image processing modules connected to the bus; a data converting unit connected to the bus; a memory connected to the data converting unit and operable to store image data. The data converting unit is operable to perform conversion of at least one of a data format and a data allocation method of image data transferred between the memory and one of the plurality of image processing modules.

According to the structure, when there is a difference in the data formats or data allocation methods of the image data which the plurality of image processing modules and the memory treat, the data converting unit converts the data format or data allocation method of the image data. Since each of the plurality of image processing modules does not need to be individually provided with the function to perform the data conversion, the circuit scale of the image processing device can be made small, and the data conversion can be efficiently carried out in a small number of cycles. Furthermore, according to the structure, performing the data conversion does not increase the frequency of usage of the bus; consequently, the image-processing efficiency of the image processing device can not be lowered.

A second aspect of the present invention provides the image processing device, in addition to the first aspect, wherein the data converting unit comprises a format converting module operable to convert a data format of the image data transferred between the memory and one of the plurality of image processing modules.

According to the structure, when there is a difference in the data formats of the image data which the plurality of image processing modules and the memory treat, the format converting module converts the data format of the image data. The format converting module is included in the data converting unit installed between the bus and the memory, and can respond to a case where every image processing module transfers image data to and from the memory. Since each of the plurality of image processing modules does not need to be individually provided with the function to convert the data format, the circuit scale of the image processing device can be made small, and the data format can be efficiently converted in a small number of cycles.

A third aspect of the present invention provides the image processing device, in addition to the second aspect, wherein when a data format of image data transferred from one of the plurality of image processing modules to the memory is different from a data format of the memory, the format converting module converts the data format of the transferred image data to the data format of the memory.

According to the structure, each image processing module can transfer the image data to the memory with the data format of the each image processing module. The format converting module is included in the data converting unit installed between the bus and the memory, and converts the transferred image data into image data with the data format of the memory, thereby storing the converted image data in the memory. For example, the image data of a CCD camera is transferred to the memory in YUV422 format from a video input module. In the course of the transfer, the format converting module converts the image data into image data in YUV420 format, and stores the converted image data in the memory. Therefore, every image data is stored in the memory in YUV420 format; thereby ensuring a high degree of consistency in the memory.

A fourth aspect of the present invention provides the image processing device, in addition to the second aspect, wherein when a data format of image data transferred from the memory to a destination module is different from a data format of the destination module, the format converting module converts the data format of the transferred image data to the data format of the destination module, the destination module being one of the plurality of image processing modules.

According to the structure, when image data is transferred from the memory to each image processing module, the format converting module, included in the data converting unit, converts the image data transferred from the memory into image data with the data format of the destination module. Thereby, the format-converted image data is sent to the destination module via the bus. Consider a case where the image data stored in the memory is displayed on an LCD, for example. The image data is stored in the memory in YUV420 format. The image data read from the memory is converted into image data in RGB format by the format converting module, and transferred to the video output module, and displayed on the LCD. Therefore, it is not necessary for the video output module to convert the data format into RGB format which is suitable for the LCD display. This feature increases convenience in use.

A fifth aspect of the present invention provides the image processing device, in addition to the second aspect, wherein the format converting module comprises: a format converting unit operable to convert a data format of the image data, the data format being one of a plurality of data formats; and a format non-converting unit operable to output the image data with the same data format as inputted. In the image processing device, using an externally-fed control signal, the format converting module is operable to control switching between the format converting unit and the format non-converting unit, and further operable to control selective execution of the format converting unit.

According to the structure, the image processing device can easily control, through the controller connected to the bus, the conversion of the data format performed by the format converting module. The format converting module chooses the format converting unit when the data format of the image processing module, as the destination or the source, differs from the data format of the memory, and performs a data-format conversion. When the data formats are same, the format converting module chooses a format non-converting unit that does not perform the data-format conversion substantially.

A sixth aspect of the present invention provides the image processing device, in addition to the second aspect, wherein the format converting module is operable to mutually convert a data format of the image data among at least two data formats selected from a group consisting of RGB format, YUV420 format, YUV422 format, and YUV444 format.

According to the structure, it is possible to easily realize the image processing device which is composed of various image processing modules treating the image data with the most popular data formats.

A seventh aspect of the present invention provides the image processing device, in addition to the first aspect, wherein the data converting unit comprises an allocation converting module operable to convert a data allocation method of the image data transferred between the memory and one of the plurality of image processing modules.

According to the structure, when there is a difference in the data allocation methods on the memory of the image data which the plurality of image processing modules and the memory treat, the allocation converting module converts the data allocation method of the image data. The allocation converting module is included in the data converting unit installed between the bus and the memory, and can respond to a case when every image processing module transfers image data to and from the memory. Since each of the plurality of image processing modules does not need to be individually provided with the function to convert the data allocation method, the circuit scale of the image processing device can be made small, and the data allocation method can be efficiently converted in a small number of cycles.

An eighth aspect of the present invention provides the image processing device, in addition to the seventh aspect, wherein when a data allocation method of image data transferred from one of the plurality of image processing modules to the memory is different from a data allocation method of the memory, the allocation converting module converts the data allocation method of the transferred image data to the data allocation method of the memory.

According to the structure, each image processing module can transfer, to the memory, image data with the data allocation method of the each image processing module. Then, the allocation converting module, included in the data converting unit installed between the bus and the memory, converts the image data into image data with the data allocation method of the memory, and stores the converted image data in the memory. Therefore, every image data is stored in the memory with the same data allocation method. This feature ensures a high degree of consistency in the memory.

A ninth aspect of the present invention provides the image processing device, in addition to the seventh aspect, wherein when a data allocation method of image data transferred from the memory to a destination module is different from a data allocation method of the destination module, the allocation converting module converts the data allocation method of the transferred image data to the data allocation method of the destination module, the destination module being one of the plurality of image processing modules.

According to the structure, when the image data is transferred from the memory to each image processing module, the allocation converting module converts the image data transferred from the memory into the image data with the data allocation method of the destination module, thereby sending the converted image data to the destination module via the bus. Therefore, each image processing module can receive, from the memory, the image data converted in the data allocation method optimal to the each image processing module. Consequently, it is not necessary for the each image processing module to convert into a new data allocation method. This feature increases convenience in use.

A tenth aspect of the present invention provides the image processing device, in addition to the seventh aspect, wherein the allocation converting module comprises: an allocation converting unit operable to convert a data allocation method of the image data, the data allocation method being one of a plurality of data allocation methods; and an allocation non-converting unit operable to output the image data with the same data allocation method as inputted. In the image processing device, using an externally-fed control signal, the allocation converting module is operable to control switching between the allocation converting unit and the allocation non-converting unit, and further operable to control selective execution of the allocation converting unit.

According to the structure, the image processing device can easily control, through the controller connected to the bus, the conversion of the data allocation method performed by the allocation converting module. The allocation converting module chooses the allocation converting unit when the data allocation method of the image processing module, as the destination or the source, differs from the data allocation method of the memory, and performs conversion of the data allocation method. When the data allocation methods are same, the allocation converting module chooses the allocation non-converting unit that does not perform the conversion of the data allocation method substantially.

An eleventh aspect of the present invention provides the image processing device, in addition to the first aspect, wherein the data converting unit comprises a format-allocation converting module operable to convert at least one of a data format and a data allocation method of the image data transferred between the memory and one of the plurality of image processing modules.

According to the structure, when there is a difference in at least one of the data formats and data allocation methods of the image data which the plurality of image processing modules and the memory treat, the format-allocation converting module converts different one of the data formats and data allocation methods of the image data. The format-allocation converting module is included in the data converting unit installed between the bus and the memory, and can respond to a case where any one of the image processing modules transfers image data to and from the memory. Therefore, each image processing module does not need to be individually provided with the function to convert the data format and the data allocation method. Furthermore, the data format and data allocation method of the image data can be simultaneously converted, if necessary; thus ensuring further convenience in use. According to the structure, the circuit scale of the image processing device can be made small, and the data format and the data allocation method can be efficiently converted in a small number of cycles.

A twelfth aspect of the present invention provides the image processing device, in addition to the eleventh aspect, wherein in transferring image data from one of the plurality of image processing modules to the memory, when a data format of the transferred image data is different from a data format of the memory, the format-allocation converting module converts the data format of the transferred image data to the data format of the memory, and when a data allocation method of the transferred image data is different from a data allocation method of the memory, the format-allocation converting module converts the data allocation method of the transferred image data to the data allocation method of the memory.

According to the structure, the data format and data allocation method of the image data which is transferred from each image processing module to the memory can be simultaneously converted to the data format and data allocation method of the memory. Consequently, various data can be stored in the memory with a high degree of consistency.

A thirteenth aspect of the present invention provides the image processing device, in addition to the eleventh aspect, wherein in transferring image data from the memory to a destination module of the plurality of image processing modules, when a data format of the transferred image data is different from a data format of the destination module, the format-allocation converting module converts the data format of the transferred image data to the data format of the destination module, and when a data allocation method of the transferred image data is different from a data allocation method of the destination module, the format-allocation converting module converts the data allocation method of the transferred image data to the data allocation method of the destination module.

According to the structure, when transferring the image data from the memory to each image processing module as a destination module, the format-allocation converting module can convert simultaneously the data format and data allocation method of the image data into the data format and data allocation method of the destination module. Therefore, convenience in use is ensured.

A fourteenth aspect of the present invention provides the image processing device, in addition to the eleventh aspect, wherein the format-allocation converting module comprises: a format converting unit operable to convert a data format of the image data, the data format being one of a plurality of data formats; a format non-converting unit operable to output the image data with the same data format as inputted; an allocation converting unit operable to convert a data allocation method of the image data, the data allocation method being one of a plurality of data allocation methods; and an allocation non-converting unit operable to output the image data with the same data allocation method as inputted. Using an externally-fed control signal, the format-allocation converting module is operable to control: switching between the format converting unit and the format non-converting unit; selective execution of the format converting unit; switching between the allocation converting unit and the allocation non-converting unit; and selective execution of the allocation converting unit.

According to the structure, in the image processing device, the controller connected to the bus can simultaneously control conversion of the data format and the data allocation method, using the format-allocation converting module.

A fifteenth aspect of the present invention provides the image processing device, in addition to the eleventh aspect, wherein the format-allocation converting module is operable to mutually convert a data format of the image data among at least two data formats selected from a group consisting of RGB format, YUV420 format, YUV422 format, and YUV444 format.

According to the structure, it is possible to realize the image processing device which is composed of various image processing modules treating the image data of the most popular data formats.

A sixteenth aspect of the present invention provides an image processing device comprising: a bus; a plurality of image processing modules connected to the bus; a data transfer unit connected to the bus. The data transfer unit is operable to transfer image data from a source module to a destination module, the source module being one of the plurality of image processing modules and the destination module being another of the plurality of image processing modules. When a data format of the transferred image data is different from a data format of the destination module, the data transfer unit converts the data format of the transferred image data to the data format of the destination module.

According to the structure, in transferring image data among the image processing modules, when the data format of the image data transferred from the source image processing module is different from the data format of the destination image processing module, the data transfer unit can perform the data-format conversion processing of the image data transferred; thereby, transferring the image data after conversion to the destination image processing module. Therefore, each image processing module does not need to care about which data format of the image data the destination image processing module treats. This feature allows an efficient image processing.

A seventeenth aspect of the present invention provides the image processing device, in addition to the sixteenth aspect, further comprising a memory connected to the bus, wherein the data transfer unit is further operable to convert at least one of a data format and a data allocation method of image data transferred between the memory and one of the plurality of image processing modules.

According to the structure, when there is a difference in the data format and data allocation method of the image data transferred between each image processing module and the memory, the data transfer unit can perform the data-format conversion processing and data allocation conversion processing for the image data. Then, the image data after conversion is sent to the destination. Therefore, even if each image processing module is treating the image data of a different data format and a different data allocation method, every image data is stored in the memory with the same data format and the same data allocation method. Consequently, a high degree of consistency is acquired in storing the image data in the memory. When transferring image data from the memory to each image processing module, the each image processing module can acquire the image data converted into image data with the data format and data allocation method which the each image processing module treats. Consequently, efficient data transfer can be realized.

An eighteenth aspect of the present invention provides the image processing device, in addition to the seventeenth aspect, wherein the data transfer unit comprises a local memory operable to temporally store image data of which the data transfer unit has converted at least one of a data format and a data allocation method.

According to the structure, it is possible for the data transfer unit to carry out batch processing of the data-format conversion and data-allocation-method conversion of the image data, and then to store the processed image data in the local memory temporarily. The data transfer unit can transfer the processed image data to the memory when the bus is not busy. Therefore, the congestion of the bus can be reduced and an efficient image processing can be performed.

A nineteenth aspect of the present invention provides the image processing device, in addition to the seventeenth aspect, wherein the data transfer unit is operable to mutually convert a data format of the image data among at least two data formats selected from a group consisting of RGB format, YUV420 format, YUV422 format, and YUV444 format.

According to the structure, the image data of the most popular data formats can be processed.

A twentieth aspect of the present invention provides the image processing device in addition to the first aspect, wherein the plurality of image processing modules include at least one of an MPEG1 image processing module, an MPEG2 image processing module, an MPEG4 image processing module, an H.264 image processing module, a JPEG image processing module, a graphics module, a video output module, and a video input module.

According to the structure, it is possible to realize the image processing device which can treat image data based on various coding systems.

A twenty-first aspect of the present invention provides a portable information terminal comprising: a transceiving unit operable to transmit and/or to receive (or to transceive) image data; an image processing device operable to process the image data, thereby generating processed image data; a display unit operable to display the processed image data; and a control unit operable to control the transceiving unit, the image processing device and the display unit. Furthermore, the image processing device comprises: a bus; a plurality of image processing modules connected to the bus; a data converting unit connected to the bus; a memory connected to the data converting unit, and operable to store the image data and the processed image data. In the image processing device, the data converting unit performs data conversion of image data transferred between the memory and one of the plurality of image processing modules.

According to the structure, it is possible to provide the portable information terminal equipped with the image processing device which possesses the above-mentioned features. The portable information terminal includes a mobile phone as well.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram illustrating an image processing device in Embodiment 1 of the present invention.

FIG. 2 is a block diagram illustrating an image processing device in Embodiment 2 of the present invention.

FIG. 3 is a block diagram illustrating a format converting module in Embodiment 2 of the present invention.

FIG. 4 illustrates data formats of image data to be processed by image processing modules in Embodiment 2 of the present invention.

FIG. 5 is a block diagram illustrating an image processing device in Embodiment 3 of the present invention.

FIG. 6 is a block diagram illustrating an allocation converting module in Embodiment 3 of the present invention.

FIG. 7(a) is an exemplification diagram illustrating arrangement of each component of YUV-format image data on the memory in Embodiment 3 of the present invention.

FIG. 7(b) is an exemplification diagram illustrating another arrangement of each component of YUV-format image data on the memory in Embodiment 3 of the present invention.

FIG. 7(c) is an exemplification diagram illustrating yet another arrangement of each component of YUV-format image data on the memory in Embodiment 3 of the present invention.

FIG. 8 is a block diagram illustrating an image processing device in Embodiment 4 of the present invention.

FIG. 9 is a block diagram illustrating a format-allocation converting module in Embodiment 4 of the present invention.

FIG. 10 is a block diagram illustrating an image processing device in Embodiment 5 of the present invention.

FIG. 11 is a block diagram illustrating a portable information terminal in Embodiment 6 of the present invention.

FIG. 12 is a flow chart illustrating operation in storing image data to the memory in Embodiment 1 of the present invention.

FIG. 13 is a flow chart illustrating operation in reading image data from the memory in Embodiment 1 of the present invention.

### BEST MODE FOR CARRYING OUT THE INVENTION

Embodiments of the present invention are now described with reference to the accompanying drawings.

### Embodiment 1

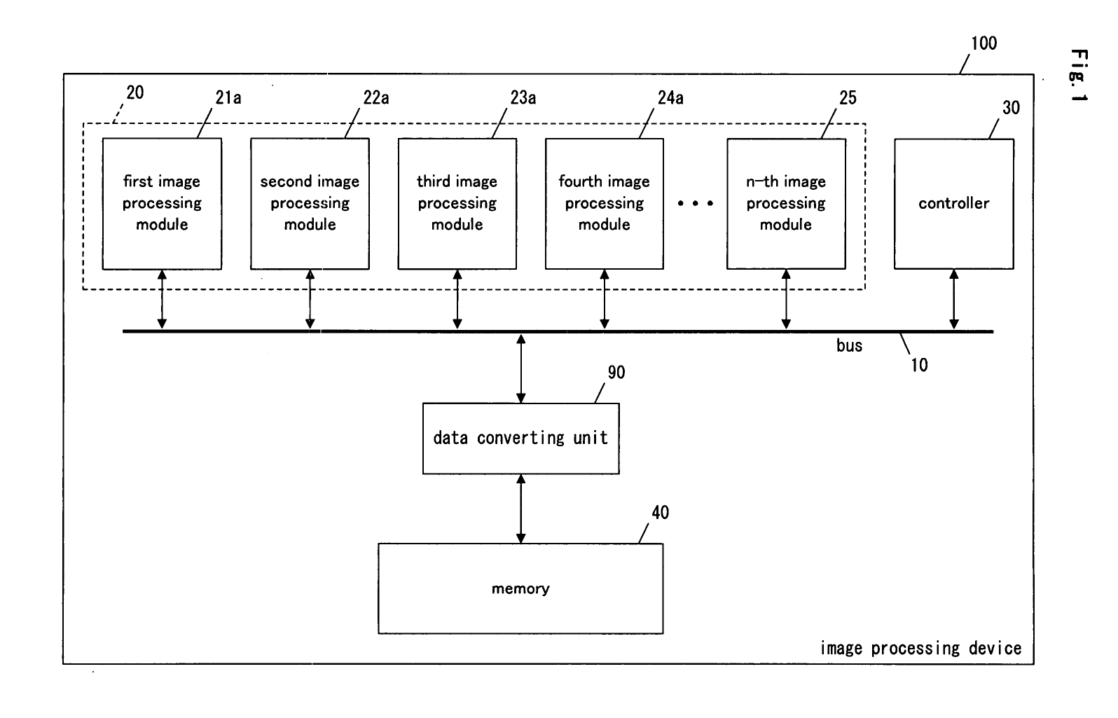

FIG. 1 is a block diagram illustrating an image processing device 100 in Embodiment 1 of the present invention. An image processing device 100 of the present embodiment comprises a bus 10, an image processing module group 20, a controller 30, a data converting unit 90, and a memory 40. The image processing module group 20, the controller 30, and the data converting unit 90 are connected to the bus 10, and the memory 40 is connected to the bus via the data converting unit 90.

The image processing module group 20 comprises a first image processing module 21a, a second image processing module 22a, a third image processing module 23a, a fourth image processing module 24a, and an n-th image processing module 25.

The controller 30 performs arbitration of the bus 10 and control of the data converting unit 90.

Each image processing module of the image processing module group 20 is composed of an image processing circuit with a dedicated function according to an application purpose of the image processing device 100 of the present embodiment. The data format and data allocation method of the image data which each image processing module processes are adapted such that each image processing module can perform its function at the highest level. As a result, the data format and the data allocation method of the image data differ in every module.

If each image processing module stores the image data into the memory 40 with each data format and each data allocation method, confusion may occur in the memory 40, since a lot of data with many different data formats and data allocation methods will be stored. When an image processing module reads and processes image data with a different data format, it is necessary to convert the data format individually, thereby, leading to inconvenience in use.

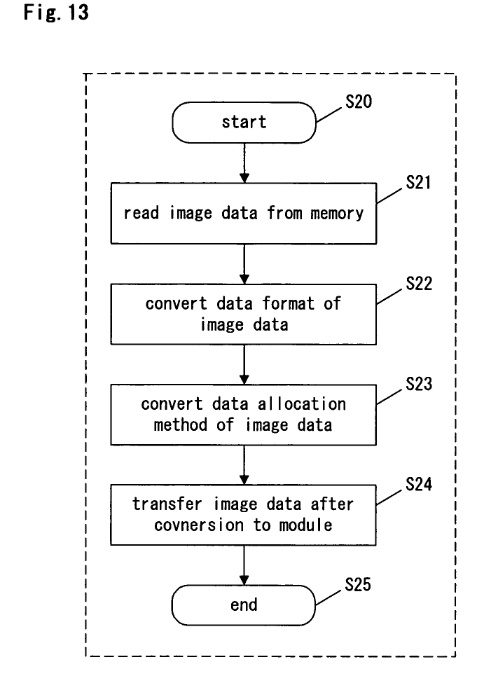

Referring to FIG. 12 and FIG. 13, the following explains the operation at the time of image data transfer between each image processing module and the memory 40, in the image processing device 100 of the present embodiment.

FIG. 12 is a flow chart when image data is stored in the memory 40 of the image processing device 100 in Embodiment 1 of the present invention.

At Step S10, the storing processing of the image data from an image processing module (a source module) to the memory 40 starts.

At Step S11, the image data to be stored is transferred from the source module to the data converting unit 90 via the bus 10.

At Step S12, the data converting unit 90 converts the data format of the image data to be stored into the data format of the memory 40.

At Step S13, the data converting unit 90 converts the data allocation method of the image data to be stored into the data allocation method of the memory 40.

At Step S14, the data converting unit 90 stores, in the memory 40, the image data of which the data format and the data allocation method have been converted.

The storing processing ends at Step S15.

By the above-mentioned processing, the image data from any image processing module is stored in the memory 40 with the same data format and the same data allocation method all the time, therefore, it is possible to avoid the confusion in the memory 40.

FIG. 13 is a flow chart when image data is read from the memory of the image processing device in Embodiment 1 of the present invention.

At Step S20, the reading processing of the image data from the memory 40 starts, in response to a request from an image processing module (a destination module).

At Step S21, the requested image data is read from the memory 40, and is sent to the data converting unit 90.

At Step S22, the data converting unit 90 converts the data format of the image data read from the memory 40 into the data format of the destination module.

At Step S23, the data converting unit 90 converts the data allocation method of the image data of which the data format is converted, into the data allocation method of the destination module.

At Step S24, the data converting unit 90 transfers the image data, of which the data format and the data allocation method are converted, to the destination module via the bus 10.

The reading processing ends at Step S25.

As explained above, the image processing device 100 of the present embodiment can smoothly perform the transfer of image data with a different data format between the image processing module group 20 and the memory 40, by installing the data converting unit 90 between the memory 40 and the bus 10.

### Embodiment 2

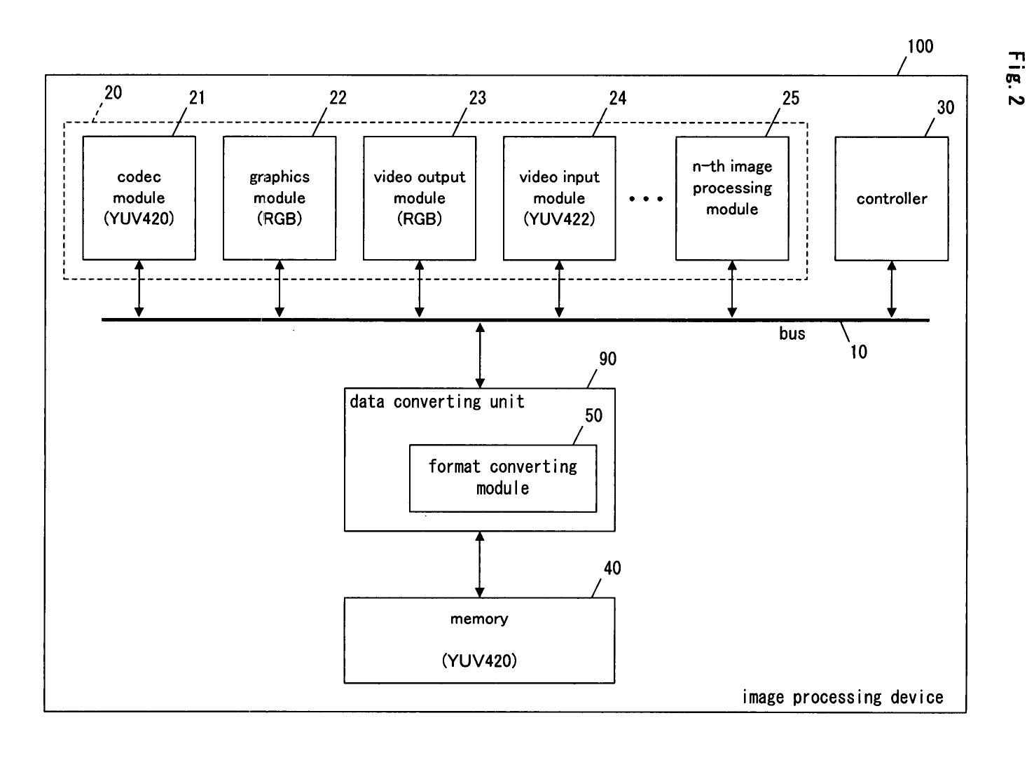

FIG. 2 is a block diagram illustrating an image processing device 100 in Embodiment 2 of the present invention. An image processing device 100 of the present embodiment comprises a bus 10, an image processing module group 20, a controller 30, a data converting unit 90, and a memory 40. The image processing module group 20, the controller 30, and the data converting unit 90 are connected to the bus 10, and the memory 40 is connected to the bus via the data converting unit 90.

The image processing module group 20 includes a codec module 21, a graphics module 22, a video output module 23, a video input module 24, and an n-th image processing module 25.

The data converting unit 90 comprises a format converting module 50.

The codec module 21 is a module which performs encoding/decoding processing of the MEPG-4 system, and treats image data of YUV420 format in the present embodiment.

The graphics module 22 is a module which specializes in graphics, and treats image data of RGB format in the present embodiment.

The video output module 23 is a module which outputs image data to an external image display device (an LCD monitor etc.), and treats image data of RGB format in the present embodiment.

The video input module 24 is a module to which image data from an external image capture device (a CCD camera etc.), image data from various recording devices (a hard disk, a non-volatile memory, etc.), or image data from a host CPU is inputted. The video input module 24 treats image data of YUV422 format in the present embodiment.

The n-th image processing module 25 is an image processing module other than those mentioned above.

The memory 40 is a memory composed of an SDRAM, a DRAM, an SRAM, or a non-volatile memory, and stores image data in YUV420 format in the present embodiment. The memory 40 is connected to the bus 10 via the format converting module 50.

The controller 30 performs arbitration of the bus 10 and control of the format converting module 50.

Thus, in the image processing device 100 of the present embodiment, each image processing module is connected to the bus 10 as a member of the image processing module group 20. Respective modules read image data stored in the memory 40, perform the respective image processing for the read image data, and then store the image data after processing in the memory 40 again. Reading and storing the image data are performed through the data transfer between the respective image processing modules and the memory 40 via the bus 10. At this time, the controller 30 performs arbitration of the bus 10 in order to prevent congestion of data transfer in the bus 10.

It should be noted that some image processing modules of the image processing module group 20 may treat image data with different data formats.

In the image processing device 100 of the present embodiment, the image data transferred from each image processing module of the image processing module group 20 is converted into the image data of YUV420 format by the format converting module 50, and is stored in the memory 40. Therefore, if any image data of any data format is sent from any image processing module, the memory 40 always stores the image data in YUV420 format.

When an image processing module of the image processing module group 20 makes a request of reading image data from the memory 40, the image data is read in YUV420 format from the memory 40. In the format converting module 50, the data format of the image data is converted into the data format of the image processing module which has made the request of reading (or a destination image processing module), and the converted image data is transferred to the destination image processing module via the bus 10.

As explained above, the image processing device 100 of the present embodiment can smoothly perform transfer of image data with different data formats between the image processing module group 20 and the memory 40, by installing the format converting module 50 in the data converting unit 90 located between the memory 40 and the bus 10.

The format converting module 50 of the present embodiment is explained in more detail.

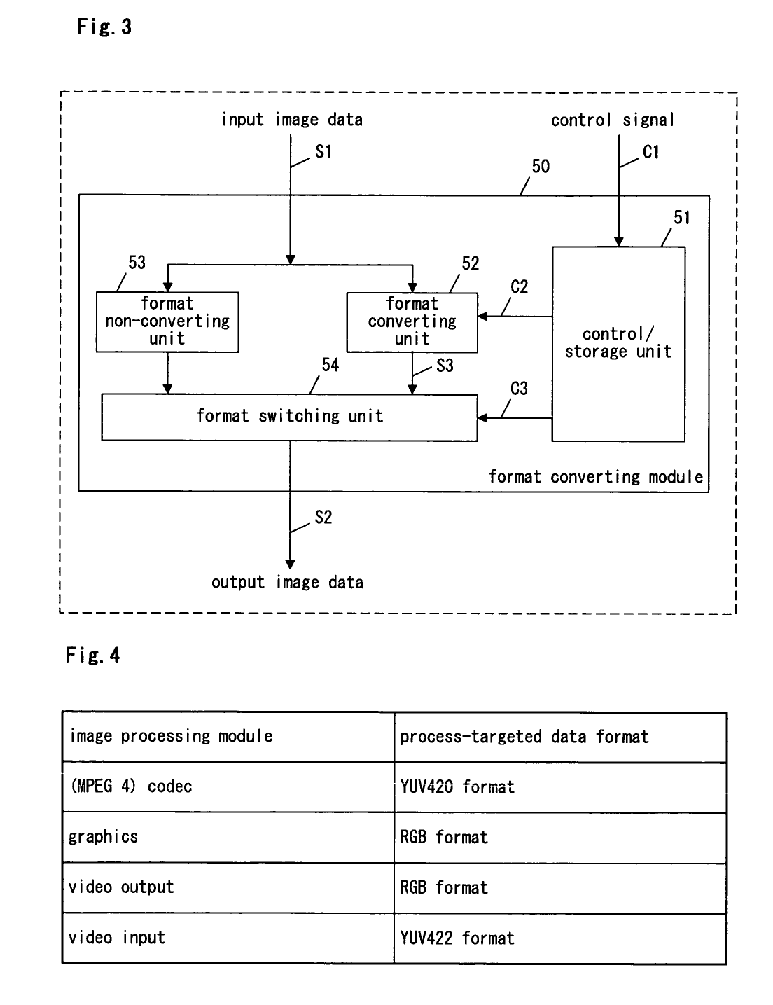

FIG. 3 is a block diagram illustrating a format converting module 50 in Embodiment 2 of the present invention. The format converting module 50 of the present embodiment comprises a format converting unit 52 operable to convert data formats, a format non-converting unit 53, a format switching unit 54 operable to switch output of the data converting unit 52 and output of the format non-converting unit 53, and a control/storage unit 51 operable to control these units.

In the format converting module 50 of the present embodiment, when image data is transferred from the image processing module group 20 to the memory 40, the input image data SI is inputted from the bus 10, and the output image data S2 is outputted to the memory 40 after the data format is converted. On the contrary, when image data is transferred from the memory 40 to the image processing module group 20, the input image data SI is inputted from the memory 40, and the output image data S2 is outputted to the bus 10 after the data format is converted.

The format converting unit 52 possesses a data-format conversion function to perform conversion and inverse conversion, such as from RGB format to YUV420 format, from YUV 422 format to YUV420, and from YUV444 format to YUV420 format, and vice versa. Thereby, the format converting unit 52 performs the data-format conversion to the input image data S1, and outputs the converted image data as the image data S3.

The format non-converting unit 53 does not substantially perform any processing, and outputs the input image data S1 as it is.

The format switching unit 54 switches the input image data S1 equal to the output of the format non-converting unit 53, and the image data S3 that is the output of the format converting unit 52, and then outputs the switched image data as the output image data S2.

The control/storage unit 51 issues a control signal C2, according to a control signal Cl from the controller 30 shown in FIG. 2, thereby controlling the format converting unit 52 to determine conversion between which data formats should be performed. The control/storage unit 51 issues a control signal C3 according to the control signal C1, thereby controlling the selection of the format switching unit 54. The control/storage unit 51 stores the control signal C1 from the controller 30 and the control information related thereto.

FIG. 4 shows an example of the process-targeted data format of each image processing module in Embodiment 2 of the present invention.

The following describes an illustrative example of image processing using the image processing device 100 of the present embodiment shown in FIG. 2.

It is assumed that each image processing module of the image processing module group 20 performs each image processing to the image data which possesses the corresponding process-targeted data format as shown in FIG. 4. It is also assumed that the memory 40 stores the image data in YUV420 format.

The image data in YUV422 format is inputted into the video input module 24 from the external image capture device (a CCD camera etc.). The inputted image data in YUV422 format is transferred from the video input module 24 to the memory 40 via the format converting module 50 when the access right to the memory 40 is secured as a result of arbitration of the bus 10 by the controller 30. In the format converting module 50, the image data in YUV422 format is converted into image data in YUV420 format, and is stored in the memory 40.

Next, the encoded data of a motion image compressed by the MPEG4 system, which is stored in the memory 40 beforehand, is transferred to the codec module 21. In the codec module 21, expansion processing of the encoded data is performed according to the MPEG4 system. At this time, the data transfer from the memory 40 to the codec module 21 is performed via the format converting module 50. In the format converting module 50, the format switching unit 54 is controlled so as to select the output of the format non-converting unit 53. Therefore, the conversion of the data format is not performed substantially, and the data read from the memory 40 is transferred to the codec module 21 in the data format as it is.

The expanded motion image data, for which the codec module 21 has performed the expansion processing based on the MPEG4 system, is transferred to the memory 40 in YUV420 format. On the present occasion, in the format converting module 50, the format switching unit 54 is controlled so as to select the output of the format non-converting unit 53, similarly as mentioned above. Therefore, the expanded motion image data is stored in the memory 40 in the data format as it is.

Next, the graphics module 22 reads the expanded motion image data (YUV420 format) from the memory 40, and performs graphics processing to the data concerned. On that occasion, during the expanded motion image data is transferred from the memory 40 to the graphics module 22, the data-format conversion is performed from YUV420 format to RGB format in the format converting module 50.

The image data, to which the graphics processing has been performed in the graphics module 22, is stored in the memory 40 again. In the format converting module 50, the data format of the image data after the graphics processing is converted from RGB format to YUV420 format before storing.

The image data (YUV420 format) after the graphics processing, which is stored in the memory 40, is read out again by the codec module 21 to undergo the compression processing. During the reading by the codec module 21, no conversion of the data format is performed in the format converting module 50. It is because the codec module 21 treats the image data of YUV420 format. The encoded data after the compression processing by the codec module 21 is stored in the memory 40 without undergoing the data-format conversion in the format converting module 50.

Next, the graphics-processed image data (YUV420 format), which is stored in the memory 40, and the input image data, which is inputted from the video input module 24 and already stored in the memory 40 (converted from YUV422 format to YUV420 format, and stored in the memory 40), are to be compounded by the video output module 23 to be outputted to a display such as an external LCD monitor. When transferring the graphics-processed image data and the input image data from the memory 40 to the video output module 23, both of the data need to be converted into image of RGB format. In the format converting module 50, the data is converted from YUV420 format to RGB format, and is transferred. In the video output module 23, both of the transferred data are compounded, and are outputted to the external LCD monitor etc.

The above is an example of image processing for which the image processing device 100 of the present embodiment is employed. Contents and order of processing in the image processing module group 20 of the image processing device 100 are constructed according to application purposes.

In the image processing device 100 of the present embodiment, the memory 40 stores only the image data of YUV420 format. However, image data of different data formats may be stored in the memory 40, by separately arranging one data format per one area.

In the example of the above-mentioned image processing, when the graphics module 22 and the video output module 23 read out the image data from the memory 40, it is necessary to convert the read image data into image data in RGB format, which is suitable for the respective processing of the modules.

In the conventional image processing device, both of the graphics module 22 and the video output module 23 need to be equipped with the data-format conversion function which performs the same conversion processing to RGB format. According to the image processing device 100 of the present embodiment, by arranging the format converting module 50 between the memory 40 and the bus 10, a plurality of image processing modules of the image processing module group 20 can share the format converting module 50. Therefore, it is also possible to reduce the circuit scale of the image processing device 100. Especially when various kinds of image processing are performed, a lot of image processing modules are necessary; therefore, the effect of the above-mentioned circuit scale reduction is more remarkable.

In the image processing device 100 of the present embodiment explained above, the controller 30 performs the arbitration of the bus 10 and the control of the format converting module 50. However, the arbitration and the control may be performed by using a register setup etc., from the exterior of the image processing device 100.

In the image processing device 100 of the present embodiment, the codec module 21 performs the codec processing of the MPEG4 system. However, the case is an example of the image processing module which performs the image compression/expansion processing, and does not specify the image compression/expansion method. The image processing module may be an alternative image processing module which performs the image compression/expansion processing of other systems, for example, the MPEG1 system, the MPEG2 system, or the H.264 system. The codec module 21 may be equipped with only either function of compression processing or expansion processing. Furthermore, the codec module 21 may be an image processing module which performs still-image compression/expansion processing, based on the JPEG system.

The bus 10 of the present embodiment does not specify the bus arrangement. The bus may adopt structure which meets the specification of the system, such as a hierarchy bus, a crossbar, a ring-shaped network, and a multi-bus.

### Embodiment 3

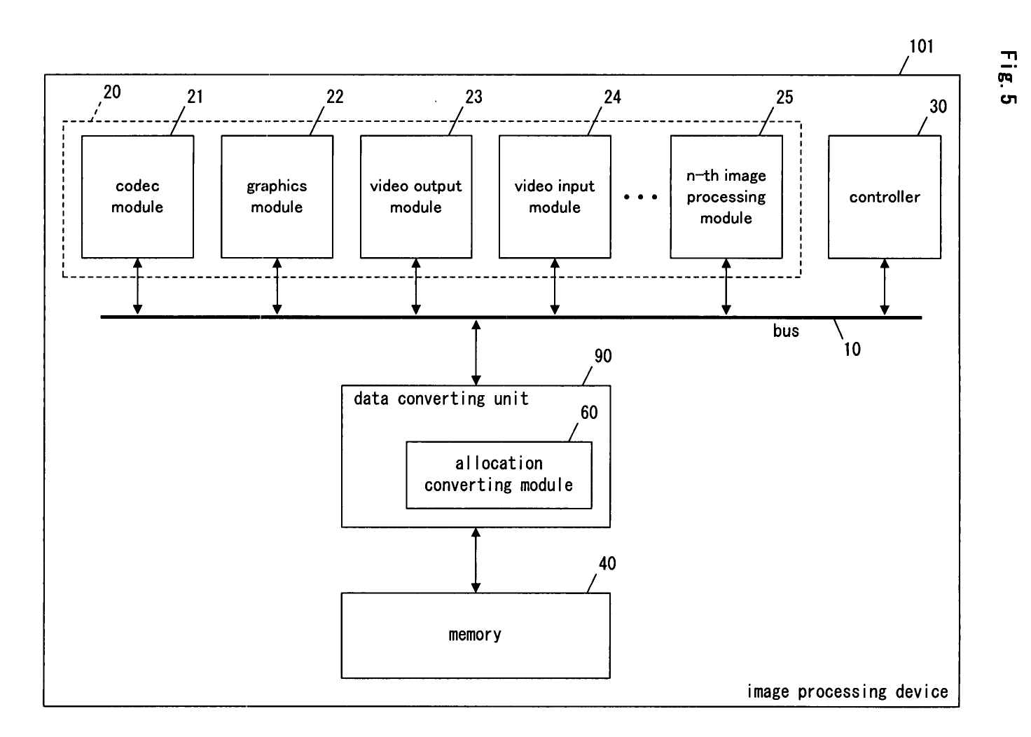

FIG. 5 is a block diagram illustrating an image processing device 100 in Embodiment 3 of the present invention. In FIG. 5, the same symbols are given to elements each having the same function as elements of FIG. 2 in order to omit explanation.

The image processing device 100 of the present embodiment shown in FIG. 5 comprises a bus 10, an image processing module group 20, a controller 30, a data converting unit 90, and a memory 40. The image processing module group 20, the controller 30, and the data converting unit 90 are connected to the bus 10, and the memory 40 is connected to the bus via the data converting unit 90.

The image processing module group 20 of the present embodiment is the same as the image processing module group 20 in Embodiment 2 of the present invention.

The data converting unit 90 comprises an allocation converting module 60.

The controller 30 performs arbitration of the bus 10 and control of the allocation converting module 60.

The allocation converting module 60 converts a data allocation method of the image data which the image processing module group 20 treats. The allocation converting module 60 stores the converted image data in the memory 40. The following explains this point in detail.

As shown in FIG. 4, the process-targeted data formats of every image processing modules of the image processing module group 20 are different. On top of that, even when the process-targeted data formats are the same, suitable data allocation methods in the memory may be different.

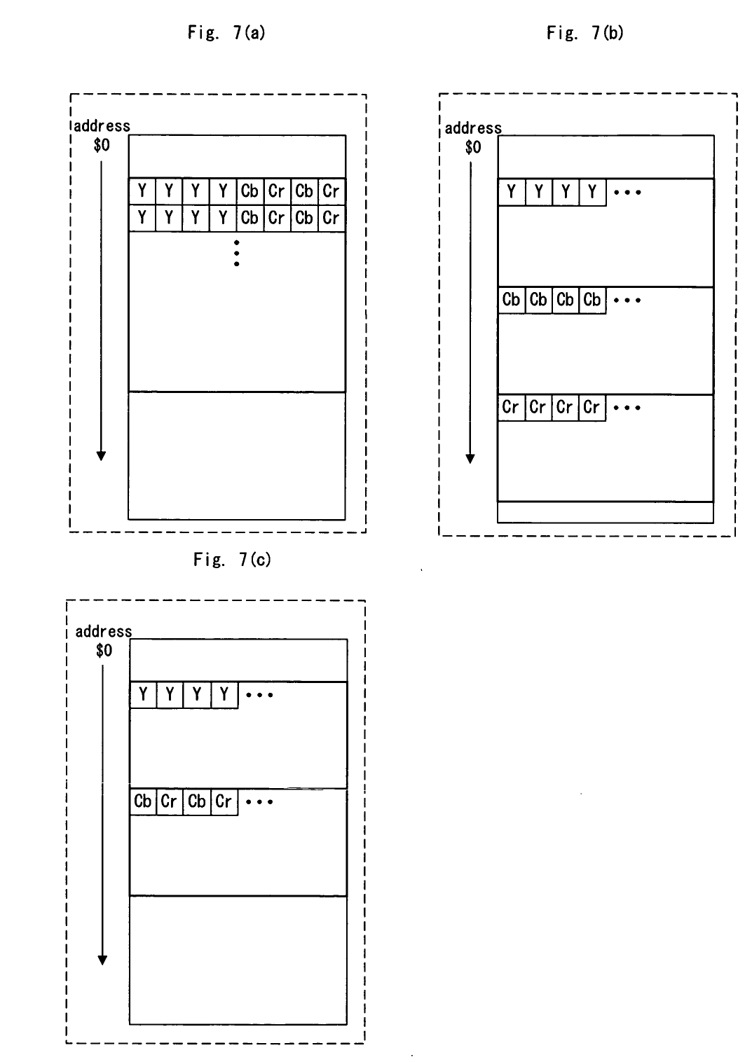

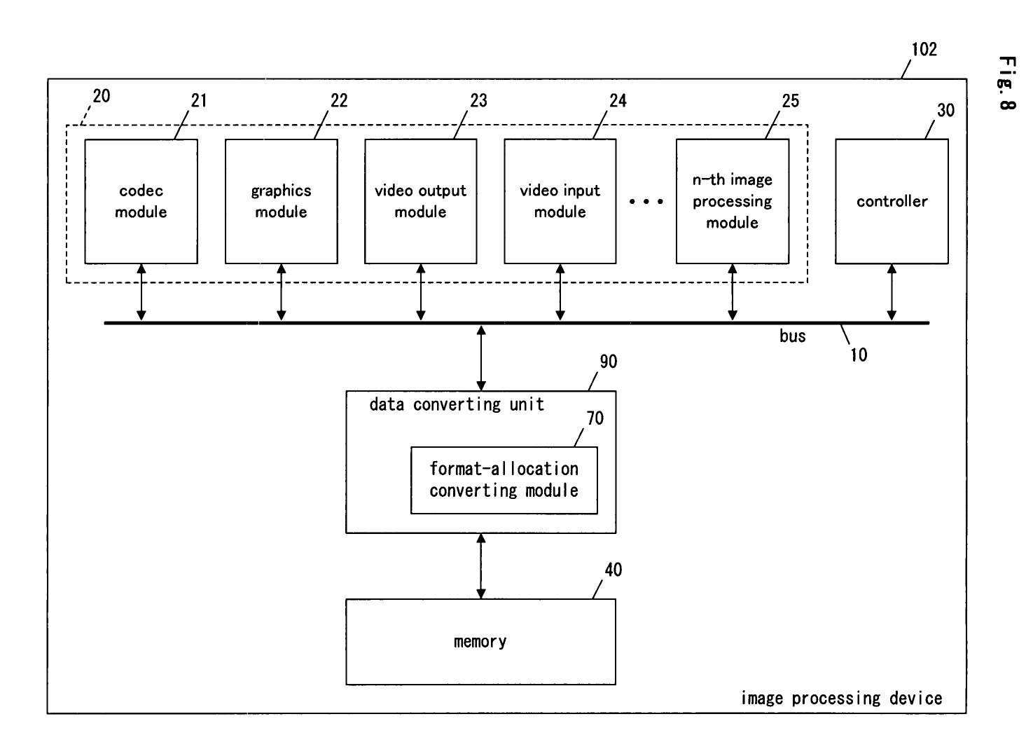

FIG. 7 shows examples of arrangement in the memory of each component of the YUV-format image data.

The arrangement examples in the memory of each component (Y, Cb, and Cr components) of the YUV-format image data include the following cases, that is, a case where each YUV component is arranged in the memory in pixel unit as shown in FIG. 7(a), a case where each YUV component is arranged in the memory per component as shown in FIG. 7(b), and a case where only Cb and Cr components are arranged in pixel unit as shown in FIG. 7(c).

In the image processing device 100 shown in FIG. 5, the input image data from the video input module 24 is stored in the memory 40, as arranged as shown in FIG. 7(a) when stored in the order of input. On the other hand, the codec module 21 requires the process-targeted data to be arranged in the memory as shown in FIG. 7(c). When the codec processing of the MPEG4 system is performed to image data with the memory arrangement as shown in FIG. 7(a), it is necessary to equip a complicated memory addressing function in order to read desired image data from the memory 40, because the image data is arranged in a distributed manner.

In the image processing device 100 of the present embodiment shown in FIG. 5, the data converting unit 90 located between the memory 40 and the bus 10 comprises the allocation converting module 60. Thereby, when the image data to be transferred passes the allocation converting module 60, the image data is attached with an address generated by the allocation converting module 60 so that the image data has a suitable memory arrangement for an image processing module that the image data is processed next. Then, the image data is stored in the memory 40.

The following explains the allocation converting module 60 of the present embodiment in detail.

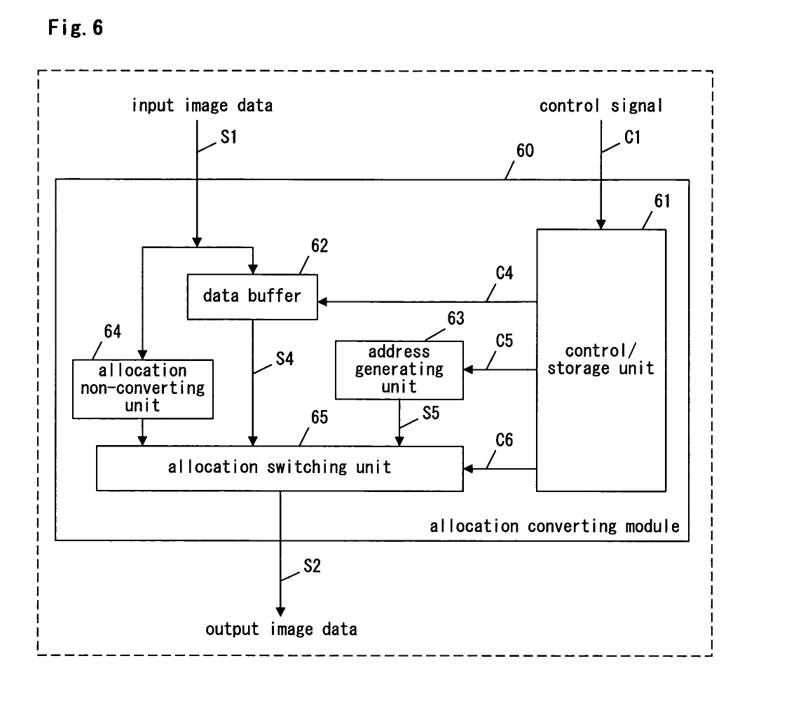

FIG. 6 is a block diagram illustrating the allocation converting module 60 in Embodiment 3 of the present invention. The allocation converting module 60 of the present embodiment comprises a control/storage unit 61, a data buffer 62, an address generating unit 63, an allocation non-converting unit 64, and an allocation switching unit 65.

In the allocation converting module 60 of the present embodiment, when image data is transferred from the image processing module group 20 to the memory 40, the input image data S1 is inputted from the bus 10 and the data allocation method is converted, then the output image data S2 is outputted to the memory 40. On the contrary, when the image data is transferred from the memory 40 to the image processing module group 20, the input image data S1 is inputted from the memory 40 and the data allocation method is converted, then the output image data S2 is outputted to the bus 10.

According to the control signal C1 from the controller 30 shown in FIG. 5, the control/storage unit 61 controls the data buffer 62 by sending a control signal C4, and controls the address generating unit 63 by sending a control signal C5, and controls the allocation switching unit 65 by sending a control signal C6. The control/storage unit 61 stores control information such as the control signal C1.

When the data allocation method of the image data to be transferred does not need to be converted, the control/storage unit 61 gives an instruction of “no arrangement conversion” to the allocation switching unit 65. Then, the allocation switching unit 65 selects the output of the allocation non-converting unit 64. The allocation non-converting unit 64 outputs the input image data S1 as the output image data S2 without performing the allocation conversion to the input image data S1.

On the other hand, when the data allocation method of the image data to be transferred needs to be converted, the control/storage unit 61 issues an instruction of “allocation conversion” to the allocation switching unit 65. The allocation switching unit 65 selects the image data S4 which is the output of a data buffer 62, and the address data S5 which the address generating unit 63 has generated. The allocation switching unit 65 attaches the new address to the image data S4, and then outputs the image data as the output image data S2. The address data S5, which the address generating unit 63 generates, is the address of the re-allocation destination. The data buffer 62 stores the input image data S1 temporarily, and outputs the input image data S1 as the image data S4 by synchronizing with the address data S5 which the address generating unit 63 outputs.

As explained above, in the image processing device 100 of the present embodiment, the allocation converting module 60 is equipped with the memory addressing function; therefore, each image processing module of the image processing module group 20 does not need to be equipped with a complicated memory addressing function individually. As a result, the image processing device 100 of the present embodiment can reduce the circuit scale, and can further perform the image processing at high-efficiency by realizing the memory arrangement that is suitable to each image processing module.

### Embodiment 4

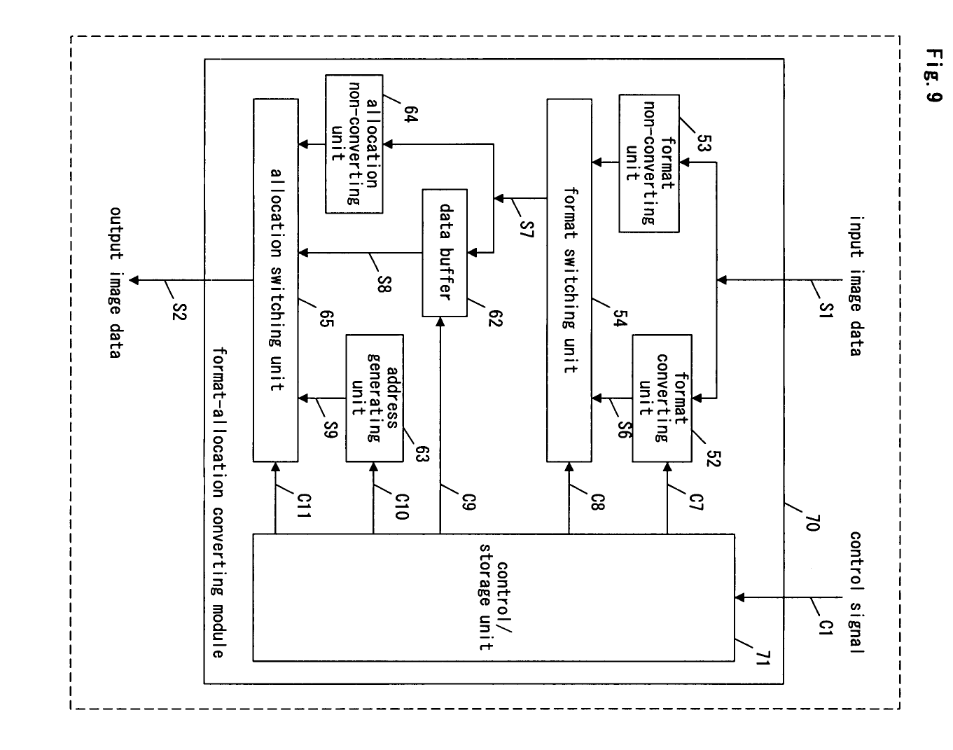

FIG. 8 is a block diagram illustrating an image processing device 100 in Embodiment 4 of the present invention. In FIG. 8, the same symbols are given to elements each having the same function as elements of FIG. 2 in order to omit explanation.

The image processing device 100 of the present embodiment shown in FIG. 8 comprises a bus 10, an image processing module group 20, a controller 30, a data converting unit 90, and a memory 40. The image processing module group 20, the controller 30, and the data converting unit 90 are connected to the bus 10, and the memory 40 is connected to the bus via the data converting unit 90.

The image processing module group 20 of the present embodiment is the same as the image processing module group 20 in Embodiment 2 of the present invention.

The data converting unit 90 comprises a format-allocation converting module 70.

The controller 30 performs arbitration of the bus 10 and control of the format-allocation converting module 70.

The format-allocation converting module 70 converts the data format and data allocation method of the image data which the image processing module group 20 treats. After then, the format-allocation converting module 70 stores the converted image data in the memory 40. Or conversely, the format-allocation converting module 70 converts the image data read from the memory 40 into the image data possessing the data format and data allocation method that are suitable to the destination image processing module. Then, the format-allocation converting module 70 sends the converted image data to the destination image processing module.

In the transfer of the image data between the image processing module group 20 and the memory 40, the image processing device 100 of the present embodiment is effective, especially when the data format and data allocation method of the image data need to be converted simultaneously.

The following describes the format-allocation converting module 70 of the present embodiment.

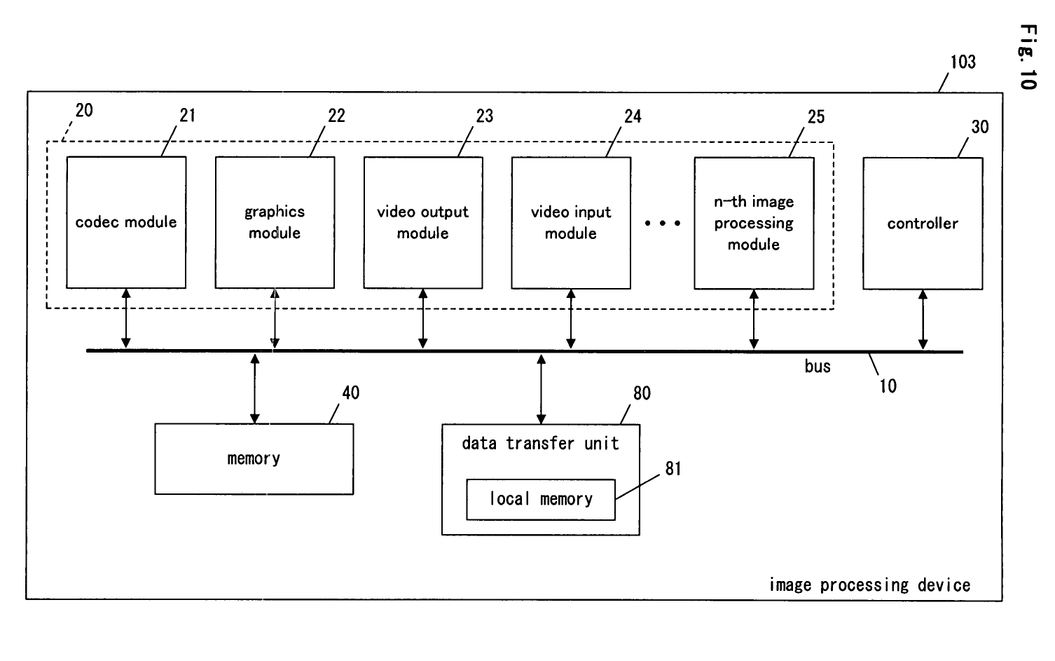

FIG. 9 is a block diagram illustrating a format-allocation converting module 70 in Embodiment 4 of the present invention. The format-allocation converting module 70 of the present embodiment comprises, as a part converting the data format, a format converting unit 52, a format non-converting unit 53, and a format switching unit 54; and as a part converting the data allocation method, a data buffer 62, an address generating unit 63, an allocation non-converting unit 64, and an allocation switching unit 65. The format-allocation converting module 70 further comprises a control/storage unit 71 operable to control all the units described above.

In the format-allocation converting module 70 of the present embodiment, when image data is transferred from the image processing module group 20 to the memory 40, the input image data S1 is inputted from the bus 10, and then the output image data S2 is outputted to the memory 40, after the data format and data allocation method of the image data are converted. On the contrary, when the image data is transferred from the memory 40 to the image processing module group 20, the input image data S1 is inputted from the memory 40, and the output image data S2 is outputted to the bus 10, after the data format and data allocation method of the image data are converted.

From the controller 30 shown in FIG. 8, the control information regarding the conversion of the data format and data allocation method is sent to the control/storage unit 71 as the control signal C1. According to the control signal C1, the control/storage unit 71 controls the format converting unit 52 by sending a control signal C7, the format switching unit 54 by sending a control signal C8, the data buffer 62 by sending a control signal C9, the address generating unit 63 by sending a control signal C10, and the allocation switching unit 65 by sending a control signal C11.

In the former part converting the data format, the control by the control signals C7 and C8 and the subsequent operation of each unit are the same as those of the format converting module 50 shown in FIG. 3 and explained in Embodiment 3 of the present invention. The result of conversion in the data format is outputted as the image data S7, and is inputted into the latter part converting the data allocation method.

In the latter part converting the data allocation method, the control by the control signals C9, C10 and C11 and the subsequent operation of each unit are the same as those of the format converting module 60 shown in FIG. 3 and explained in Embodiment 3 of the present invention. The result of conversion in the data format and data allocation method is outputted as the output image data S2.

According to the image processing device 100 of the present embodiment, the functions of the data-format conversion and the data-allocation-method conversion are the same as in Embodiment 2 and Embodiment 3, respectively. By performing the data-format conversion and the data-allocation-method conversion en bloc, the necessary number of access time to the memory is once; compared with two times in the necessary number of access time to the memory when the conversions are performed individually. As a result, reduction of the frequency of memory access and reduction of the data congestion in the bus 10 are achieved; thereby realizing the improvement in the speed of the image processing.

### Embodiment 5

FIG. 10 is a block diagram illustrating an image processing device 100 in Embodiment 5 of the present invention. In FIG. 10, the same symbols are given to elements each having the same function as elements of FIG. 2 in order to omit explanation.

The image processing device 100 of the present embodiment shown in FIG. 10 comprises a bus 10, an image processing module group 20 connected to the bus 10, a controller 30 connected to the bus 10, a memory 40 connected to the bus 10, and a data transfer unit 80 connected to the memory 40. The data transfer unit 80 comprises a local memory 81.

The image processing device 100 of the present embodiment characteristically comprises the memory 40 and the data transfer unit 80, both being directly connected to the bus 10. The data transfer unit 80 of the present embodiment possesses the functions operable to convert the data format and data allocation method of the image data to be transferred via the bus 10 and at the same time possesses the function operable to arbitrate the data transfer via the bus 10. Therefore, in the present embodiment, the controller 30 does not need to perform arbitration of the data transfer via the bus 10, and can spend the otherwise necessary time to perform the other control and processing in the image processing device 100.

The conversion processing of the data format and data allocation method for the image data practiced by the data transfer unit 80 of the present embodiment is basically the same as the conversion processing practiced by the format-allocation converting module 70 of Embodiment 4 of the present embodiment shown in FIG. 9.

However, the data transfer unit 80 of the present embodiment comprises the local memory 81, and can process the data format conversion and data allocation method conversion of the image data en bloc.

For example, image data is sent en bloc from an image processing module of the image processing module group 20 to the local memory 81, and the data format of the image data is converted en bloc by the data transfer unit 80, and after then the converted image data is stored in the local memory 81. Then, when the bus 10 is not crowded, the converted image data is transferred en bloc to the memory 40. Similarly, it is possible to convert the data allocation method of the image data en bloc.

As clearly explained above, the image processing device of the present embodiment can greatly reduce the number of access time to the memory 40; therefore, efficient operation of the memory 40 becomes possible. In addition, when transferring image data from one image processing module of the image processing module group 20 to another image processing module, it is possible to convert the data format by using the data transfer unit 80 and to transfer the converted image data to the destination; thereby the data format can be converted without passing through the memory 40. As a result, the burden of the memory 40 is further reduced, leading to realization of the efficient image processing.

### Embodiment 6

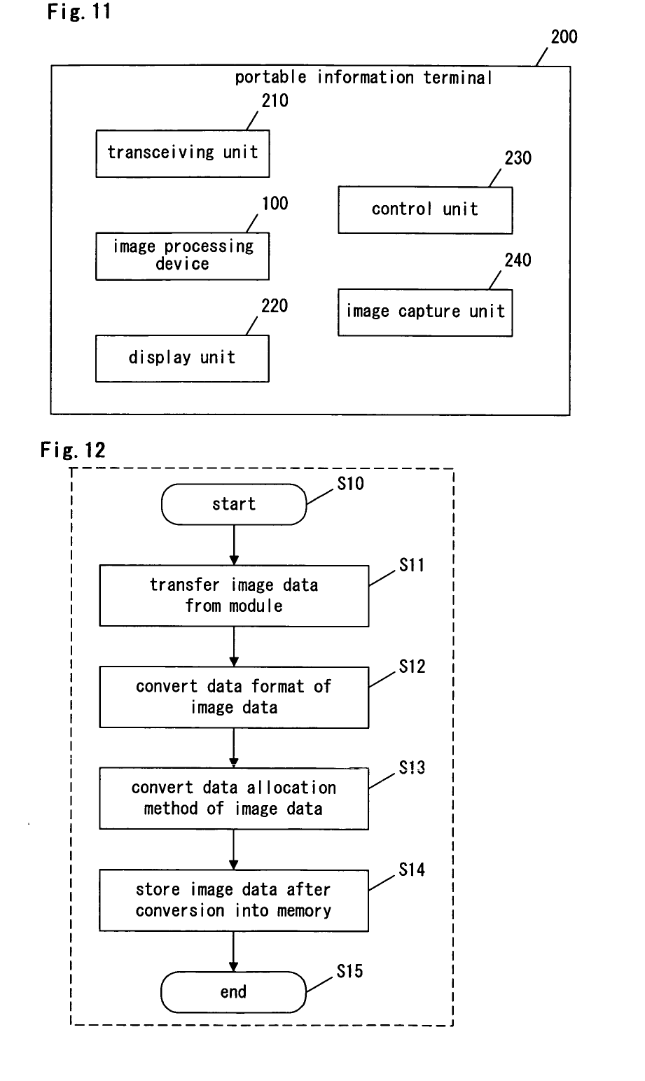

FIG. 11 is a block diagram illustrating a portable information terminal 200 in Embodiment 6 of the present invention.

The portable information terminal 200 of the present embodiment shown in FIG. 11 comprises a transceiving unit 210, an image processing device 100, a display unit 220, a control unit 230, and an image capture unit 240.

The following explains a case where the portable information terminal 200 of the present embodiment is applied to a camera-equipped mobile phone.

The transceiving unit 210 performs transmission and reception between the portable information terminal 200 and the radio base station. The image processing device 100 is either one of the image processing devices 100 which are explained in Embodiment 1 to Embodiment 5.

The display unit 220 is an LCD connecting to the video output module 23 of the image processing device 100.

The control unit 230 performs control of the overall portable information terminal 200.

The image capture unit 240 is a CCD camera connecting to the video input module 24 of the image processing device 100.

In the portable information terminal 200 of the present embodiment, when transmitting, the image capture unit 240 shoots images, and the video input module 24 of the image processing device 100 takes in the image data. The image data is stored in the memory 40, and is displayed on the display unit 220. The portable information terminal 200 sends the image data, which is temporarily stored in the memory 40, to the codec module 21 of the image processing device 100, encodes the image data, and transmits from the transceiving unit 210 to a portable information terminal 200 of the other end's user via the radio base station.

When receiving, in the portable information terminal 200 of the present embodiment, the transceiving unit 210 receives the image data, which is sent from the portable information terminal 200 of the other end's user via the radio base station, and the codec module 21 of the image processing device 100 decodes the image data. The image data is stored in the memory 40, and is displayed on the display unit 220 from the video output module 23.

When transmission and reception of the image data are performed, during the data transfer between the memory 40 in the image processing device 100 and each of the image processing modules 21 to 25, the data converting unit 90 performs the conversion of the data format and the data allocation method, and the memory 40 stores the image data according to a defined data format and data allocation method.

When one of the image processing devices 100 explained in Embodiments 1 to 5 is applied to the image processing device 100 of the portable information terminal 200, it is possible to provide a portable information terminal superior in the image processing capability, such as a camera-equipped mobile phone.

As explained above, the main purport of the present invention lies in realizing the image processing at high efficiency by introducing a format converting/allocation converting module operable to perform the conversion of the data format and data allocation method of image data at one place. Thus, as long as it falls in the main purport of the present invention, various applications can be used.

According to the present invention, by introducing a new module operable to perform the data-format conversion processing and data reallocation processing at the time of data transfer between a plurality of image processing modules or between one of the plurality of image processing modules and the memory, it is possible to provide the image processing device operable to perform the image processing in various ways, where the plurality of the image processing modules collaboratively operate.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

### INDUSTRIAL APPLICABILITY

The image processing device related to the present invention can be used in electronic equipment accompanying image processing and applicable fields related thereto, such as a portable information terminal that performs various kinds of image processing, typified by a camera-equipped mobile phone.

1. An image processing device comprising:
a bus;
a plurality of image processing modules connected to said bus;
a data converting unit connected to said bus;
a memory connected to said data converting unit and operable to store image data,
wherein said data converting unit is operable to perform conversion of at least one of a data format and a data allocation method of image data transferred between said memory and one of said plurality of image processing modules.

2. The image processing device as defined in claim 1, wherein said data converting unit comprises a format converting module operable to convert a data format of the image data transferred between said memory and one of said plurality of image processing modules.

3. The image processing device as defined in claim 2, wherein when a data format of image data transferred from one of said plurality of image processing modules to said memory is different from a data format of said memory, said format converting module converts the data format of the transferred image data to the data format of said memory.

4. The image processing device as defined in claim 2, wherein when a data format of image data transferred from said memory to a destination module is different from a data format of the destination module, said format converting module converts the data format of the transferred image data to the data format of the destination module, the destination module being one of said plurality of image processing modules.

5. The image processing device as defined in claim 2, wherein said format converting module comprises:
a format converting unit operable to convert a data format of the image data, the data format being one of a plurality of data formats; and
a format non-converting unit operable to output the image data with the same data format as inputted, and
wherein using an externally-fed control signal, said format converting module is operable to control switching between said format converting unit and said format non-converting unit, and further operable to control selective execution of said format converting unit.

6. The image processing device as defined in claim 2, wherein said format converting module is operable to mutually convert a data format of the image data among at least two data formats selected from a group consisting of RGB format, YUV420 format, YUV422 format, and YUV444 format.

7. The image processing device as defined in claim 1, wherein said data converting unit comprises an allocation converting module operable to convert a data allocation method of the image data transferred between said memory and one of said plurality of image processing modules.

8. The image processing device as defined in claim 7, wherein when a data allocation method of image data transferred from one of said plurality of image processing modules to said memory is different from a data allocation method of said memory, said allocation converting module converts the data allocation method of the transferred image data to the data allocation method of said memory.

9. The image processing device as defined in claim 7, wherein when a data allocation method of image data transferred from said memory to a destination module is different from a data allocation method of the destination module, said allocation converting module converts the data allocation method of the transferred image data to the data allocation method of the destination module, the destination module being one of said plurality of image processing modules.

10. The image processing device as defined in claim 7, wherein said allocation converting module comprises:
an allocation converting unit operable to convert a data allocation method of the image data, the data allocation method being one of a plurality of data allocation methods; and
an allocation non-converting unit operable to output the image data with the same data allocation method as inputted, and
wherein, using an externally-fed control signal, said allocation converting module is operable to control switching between said allocation converting unit and said allocation non-converting unit, and further operable to control selective execution of said allocation converting unit.

11. The image processing device as defined in claim 1, wherein said data converting unit comprises a format-allocation converting module operable to convert at least one of a data format and a data allocation method of the image data transferred between said memory and one of said plurality of image processing modules.

12. The image processing device as defined in claim 11, wherein in transferring image data from one of said plurality of image processing modules to said memory,
when a data format of the transferred image data is different from a data format of said memory, said format-allocation converting module converts the data format of the transferred image data to the data format of said memory, and
when a data allocation method of the transferred image data is different from a data allocation method of said memory, said format-allocation converting module converts the data allocation method of the transferred image data to the data allocation method of said memory.

13. The image processing device as defined in claim 11, wherein in transferring image data from said memory to a destination module of said plurality of image processing modules,
when a data format of the transferred image data is different from a data format of the destination module, said format-allocation converting module converts the data format of the transferred image data to the data format of the destination module, and
when a data allocation method of the transferred image data is different from a data allocation method of the destination module, said format-allocation converting module converts the data allocation method of the transferred image data to the data allocation method of the destination module.

14. The image processing device as defined in claim 11, wherein said format-allocation converting module comprises:
a format converting unit operable to convert a data format of the image data, the data format being one of a plurality of data formats;
a format non-converting unit operable to output the image data with the same data format as inputted;
an allocation converting unit operable to convert a data allocation method of the image data, the data allocation method being one of a plurality of data allocation methods; and
an allocation non-converting unit operable to output the image data with the same data allocation method as inputted, and
wherein, using an externally-fed control signal, said format-allocation converting module is operable to control:
switching between said format converting unit and said format non-converting unit;
selective execution of said format converting unit;
switching between said allocation converting unit and said allocation non-converting unit; and
selective execution of said allocation converting unit.

15. The image processing device as defined in claim 11, wherein said format-allocation converting module is operable to mutually convert a data format of the image data among at least two data formats selected from a group consisting of RGB format, YUV420 format, YUV422 format, and YUV444 format.

16. An image processing device comprising:
a bus;
a plurality of image processing modules connected to said bus;
a data transfer unit connected to said bus,
wherein said data transfer unit is operable to transfer image data from a source module to a destination module, the source module being one of said plurality of image processing modules and the destination module being another of said plurality of image processing modules, and
wherein when a data format of the transferred image data is different from a data format of the destination module, said data transfer unit converts the data format of the transferred image data to the data format of the destination module.

17. The image processing device as defined in claim 16, further comprising a memory connected to said bus,
wherein said data transfer unit is further operable to convert at least one of a data format and a data allocation method of image data transferred between said memory and one of said plurality of image processing modules.

18. The image processing device as defined in claim 17, wherein said data transfer unit comprises a local memory operable to temporally store image data of which said data transfer unit has converted at least one of a data format and a data allocation method.

19. The image processing device as defined in claim 17, wherein said data transfer unit is operable to mutually convert a data format of the image data among at least two data formats selected from a group consisting of RGB format, YUV420 format, YUV422 format, and YUV444 format.

20. The image processing device as defined in claim 1, wherein said plurality of image processing modules include at least one of an MPEG1 image processing module, an MPEG2 image processing module, an MPEG4 image processing module, an H.264 image processing module, a JPEG image processing module, a graphics module, a video output module, and a video input module.

21. A portable information terminal comprising:
a transceiving unit operable to transceive image data;
an image processing device operable to process the image data, thereby generating processed image data;
a display unit operable to display the processed image data; and
a control unit operable to control said transceiving unit, said image processing device and said display unit,
wherein said image processing device comprises:
a bus;
a plurality of image processing modules connected to said bus;
a data converting unit connected to said bus;
a memory connected to said data converting unit, and operable to store the image data and the processed image data,
wherein said data converting unit performs data conversion of image data transferred between said memory and one of said plurality of image processing modules.

22. A data processing method for processing image data transferred between one of a plurality of image processing modules connected a bus and a memory connected the bus; the data processing method comprising:
transferring the image data between the memory and one of the plurality of image processing modules; and
performing data conversion of at least one of a data format and a data allocation method of the image data transferred by said transferring.

23. The data processing method as defined in claim 22, wherein said performing data conversion includes converting a data format of the image data to a data format of a destination to which the image data is transferred, when the data format of the image data is different from the data format of the destination, thereby generating format-converted image data, and
wherein said transferring includes transferring the format-converted image data to the destination.

24. The data processing method as defined in claim 22, wherein said performing data conversion includes converting a data allocation method of the image data to a data allocation method of a destination to which the image data is transferred, when the data allocation method of the image data is different from the data allocation method of the destination, thereby generating data-allocation-method-converted image data, and
wherein said transferring includes transferring the data-allocation-method-converted image data to the destination.

25. The data processing method as defined in claim 22, wherein said performing data conversion includes:
converting a data format of the image data to a data format of a destination to which the image data is transferred, when the data format of the image data is different from the data format of the destination; and
converting a data allocation method of the image data to a data allocation method of the destination, when the data allocation method of the image data is different from the data allocation method of the destination, and
wherein said transferring includes transferring to the destination the image data converted with respect to at least one of the data format and the data allocation method by said performing data conversion.

26. The data processing method as defined in claim 23, wherein the data format of the image data includes at least two formats selected from a group consisting of RGB format, YUV420 format, YUV422 format, and YUV444 format.
